(19) United States
(12) Patent Application Publication
(10) Pub. No.: US 2010/0258146 A1
(43) Pub. Date: Oct. 14, 2010

(54) Device and method for cleaning the brushes of a vehicle wash gantry

(76) Inventors: Julien Villard, Oberhoffen-Sur-Moder (FR); Christian Stacker, Mundolsheim (FR)

Correspondence Address: OLIFF & BERRIDGE, PLC, P.O. BOX 320850, ALEXANDRIA, VA, 22320-4850, US

(21) Appl. No.: 12/733,538

(22) PCT Filed: Sep. 10, 2008
(86) PCT No.: PCT/FR2008/001269

§ 371 Date: May 17, 2010

(30) Foreign Application Priority Data
Sep. 10, 2007 (EP) 07360039.7

(51) Int. Cl. B08B 3/00

(52) U.S. Cl. 134/34; 134/198

(57) ABSTRACT

Device and method for cleaning the brushes of a vehicle wash gantry, comprising nozzles spraying a fluid at pressure onto the brushes of the wash gantry. It may have means for orienting the nozzles relative to the brushes, and protective enclosure means for the brushes during cleaning.

The present invention mainly relates to a method for cleaning the brushes of a vehicle wash gantry. It however also relates to a cleaning method applied on the basis of this device.

Unlike high pressure cleaning with washing nozzles or lances spraying a liquid from a distance on vehicle bodies, brush gantries (for example with rotary rollers) act by friction involving mechanical contact, one of the well-known drawbacks of which is the generation sooner or later of scratches or a loss of gloss on the body.

Thus, over time, a sort of erosion occurs related to the repetitive contact which is produced during the action of the brush, and which affects the whole of the body. Moreover, during the interaction phase between the brush(es) and the body, scratches may be caused locally by the existence of abrasive dirt present on the body, momentarily carried away by a brush. Finally, such scratches may also be caused by dirt present not on the body but on a brush, whether prior to the beginning of the friction operation, or picked up elsewhere on the body.

This last assumption is unfortunately far from being unlikely insofar that the rollers/brushes repetitively actuated for proceeding with the washing of vehicles, are quite normally loaded with dirt/particles during the washing of a vehicle, and may consequently cause damages on the body of vehicles subsequently using the same washing device.

The invention aims at suppressing this problem by removing any dirt capable of affecting the rollers or brushes before the beginning of the washing of a vehicle. In this perspective, it is possible to perform cleaning of the brushes right from the beginning of the washing phase programmed by the customer or at the end of the washing of the previous car, for example just before the spin-drying of the brushes. Alternatively, this may be performed at the end of a washing phase, before or during the drying phase of the wash program of the previous vehicle.

In any case, the cleaning device of the invention is mainly characterized in that it includes nozzles projecting a pressurized fluid on the brushes of the wash gantry.

In other words, in addition to the possible existence of nozzles for high pressure cleaning of vehicles, which may coexist with brushes operating by direct mechanical contact with the body of the vehicle, the invention applies a pressurized fluid not intended for washing the vehicle, but intended for the wash gantry, and more particularly for the brushes with which it is equipped.

Preferably, the pressure of the projected fluid is comprised between 15 and 75 bars.

In certain wash stations, according to the range proposed by the manufacturer, the pressure used may be close to 15 bars while more performing station designs propose operating pressures close to the upper limit of the aforementioned range.

According to a possible configuration, the device of the invention includes means for orienting the nozzles relatively to the brushes of the wash gantry.

The orientation means consequently allow an adjustment with view to varying the relative position of the nozzles and of the brushes. The purpose is to orient, before cleaning the brushes, the nozzles in a predetermined direction favorable to proper cleaning of the latter, for example by orienting them tangentially to the rotary rollers, and/or to allow variation of their orientation during the cleaning of the brushes.

According to one possibility, the nozzles are mounted on the vehicle wash gantry.

Under this assumption, in the case of mixed systems, i.e. gantries including both rollers and high pressure nozzles for cleaning vehicles, the cleaning of the brushes may possibly be carried out with the same nozzles. Both functions allotted to the nozzles are then applied sequentially.

According to one alternative, the nozzles may be mounted on a gantry distinct from the vehicle wash gantry. Under this assumption, the system of the invention is therefore mounted on a specific gantry, provided for interacting with the vehicle wash gantry, for example when the latter vehicle is parked at a standstill between two washing phases.

More specifically, regardless of the considered assumption, the nozzles are integrated to at least one ramp, which may also be provided so as to be orientable.

In this case, in addition to the orientability specific to each nozzle, it is possible to proceed with pre-adjustment by adequately positioning the ramp(s) relatively to the brushes and/or to the rollers. Both adjustments for orienting the ramps and the nozzles respectively optimize the operation for cleaning the brushes.

According to the invention, the cleaning device includes a management unit capable of triggering a cycle for washing the brushes on the basis of manual or automated control, the latter being managed by the management unit on the basis of predetermined events stored in memory, which may for example be the end or the beginning of a cycle for washing a vehicle.

The brushes may be rollers performing a rotary movement, as this is frequently found in vehicle wash stations.

The device of the invention may moreover include means for mechanically acting on the brushes in order to detach dirt therefrom, means which add to the pressure of the fluid jets from the nozzles of the device and operate via mechanical contacts and impacts.

Said means may then for example for each brush consist in a comb with stringers running parallel to the brush and the flexible or rigid teeth of which are capable of interfering with the brush in motion.

According to a possible configuration, said device may further include protective enclosure means for the brushes during cleaning. Such a possibility aims at protecting the surroundings from any projection.

According to a configuration possibility, the protective enclosure means are mobile between two stable positions, an inactive position and an active position for protection against the projections during the washing of the brushes. They are therefore not permanently operational, but their application either depends on the intention of the user, or on events managed by the processing unit.

Thus, if the wash gantry assumes the form of two side brushes with a vertical appearance, associated with an upper brush with a horizontal appearance, the protective enclosure means may for example for each vertical brush include an external side protective body in contact with which at least one additional protective face extending at least partly around each vertical brush retracts in the inactive position and from which said face is deployed in the active position.

If the brushes are rollers performing a rotary movement, the external side protective body may consist in metal sheet forming a cylinder portion with an axis substantially equal to the axis of rotation of the rollers forming the brushes, in which a cylinder portion with the same radius of curvature forming the additional face will slide transversely.

In other words, the applied case may for example assume the shape of half-cylinders, one of which sliding on the other in order to enclose the brush(es) during their cleaning, said case may retract during the washing of the vehicle.

As additional mechanical means for removing dirt on the brushes, the additional face may include, extending substantially radially towards the brush, a comb or at least one strip, the latter or the teeth of the comb penetrating into the volume occupied by the roller and which the latter hits when it is rotating.

The teeth of the comb or the strips may be provided in a flexible or rigid synthetic material, hitting the strands of the brushes in order to rid them of possible dirt with the support of the action of the pressurized jets.

According to a possible configuration, the enclosure protective means for the horizontal upper brush consist in a flap, to which a displacement may be imparted between an open and closed position.

The displacement of the enclosure protective means is controlled by the processing unit mentioned earlier, which transmits deployment/retraction commands which depend on preprogrammed events, including a response to a manual command.

Up to now, a cleaning device projecting a pressurized fluid has been reported. Thus, according to one possibility, this fluid may be pressurized air. Alternatively, this may be a liquid, either including or not chemical means for cleaning the brushes. In other words, the dirt capable of scratching the bodies of the vehicles may be separated from the brushes mechanically, under the effect of the pressure of the liquid, or even of possible centrifugal forces in the case of rotary rollers, and/or chemically by action of a suitable product contained in the projected liquid, for example of the detergent type.

The projected liquid may, according to one possibility, be hot. This possibility leads to the suppression of any risk of projection of frozen particles during washes performed at a temperature close to 0°. Frozen particles may then lead to the same drawbacks as dirt on the bodies.

As mentioned earlier, the invention also relates to a cleaning method based on a device as described above. Essentially, this method is therefore characterized in that it consists of spraying a pressurized fluid on the brushes in order to clean them.

The cleaning of the brushes applied according to the method of the invention of course depends on the configuration of the gantry and on the brushes which are included therein. Under the assumption that these are rotary rollers, the latter are preferably set into rotation for their cleaning. This movement leads to optimization of the operation, by giving rise to application of forces which add to the pressure of the fluid.

During a cycle for cleaning the brushes, the latter are preferably set into rotation alternately in one direction and in the opposite direction, so that the pressurized fluid flow is applied to the rollers according to two distinct angles of incidence, which increases the efficiency of their cleaning.

According to one possibility, the duration of the rotation in each direction is comprised between 3 s and 10 s. This may for example 5 s in both directions. In this case, the rollers may be brought to a standstill during a predetermined period, between each change in direction of rotation, spraying being consequently applied also during the standstill phase, further leading to another cleaning effect.

Moreover, still for varying the effects and consequently the efficiency of the washing, at certain moments of the cleaning cycle of the brushes, provision is made according to the invention for the rollers to be driven into rotation during a predetermined period in the absence of fluid spraying. Under this assumption, dirt may be removed by centrifugation.

According to one possibility, the fluid may be sprayed on the brushes for a cycle fraction including 2 to 100 revolutions of said brushes. More specifically, said cycle fraction has a duration between 8 and 30 revolutions. As mentioned earlier, half of the revolutions are carried out in one direction, the other half being carried out in the opposite direction. If the rollers rotate at 60 revolutions per minute, a cycle fraction lasts for about ten seconds under the assumption of about ten revolutions.

This rotation cycle is then performed for example between two vehicle washes. Such a cycle for cleaning the brushes may for example be triggered automatically at the beginning or at the end of a vehicle wash cycle. Alternatively, it may be triggered manually, at will from the user, or from the manager of the vehicle washing stations.

According to still another possibility, the cycle for cleaning the brushes may be automatically triggered when at least one predetermined condition is met, which may be quantified by the cleaning management unit. This may be an inactivity period of the wash station, when no cycle has been performed during a predetermined period, for example because of frost or prolonged inactivity because of work, closure of the site, etc.

In this case, said cleaning cycle may last between 40 s and 80 s, i.e. substantially longer than in the normal case of a cycle taking place between two vehicle washing phases.

According to a possible operating mode, each brush-cleaning cycle is coupled to the closing of the protective enclosure means of the brushes and triggered when said protective enclosure means are in the closed position.

Spraying of liquid within the scope of the method may be accomplished along an orientation which is variable, i.e. during the cleaning, the orientation of the cleaning jet(s) may be modified in order to optimize the efficiency of said cleaning, the modification of the orientation may be controlled by a user via the management unit.

The invention will now be described in more detail, with reference to the appended figures, for which:

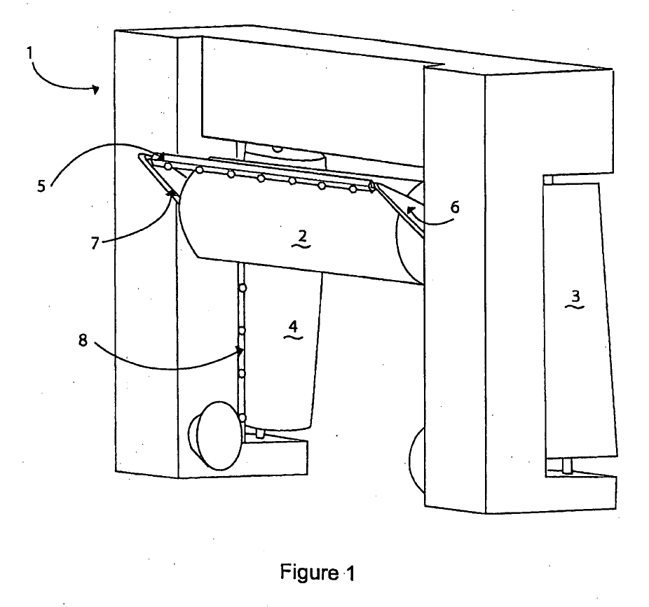

FIG. 1 illustrates in a perspective view a possibility of a cleaning device according to the invention; and

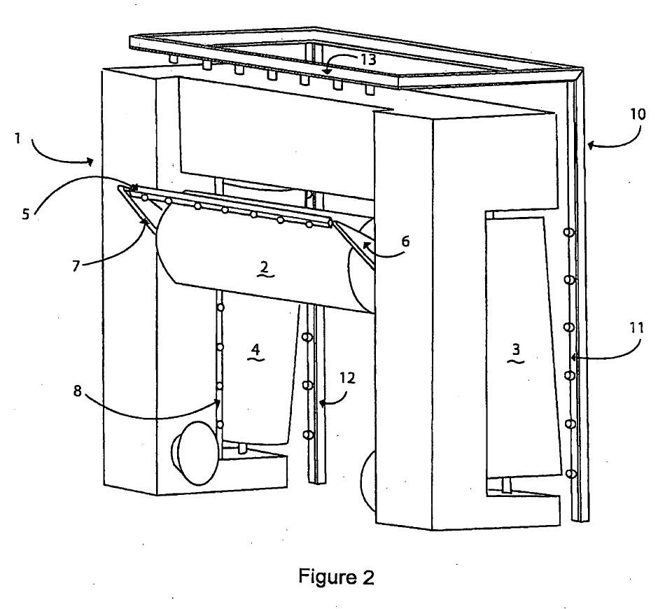

FIG. 2 shows also in a perspective view, an alternative embodiment of the device of the invention.

With reference to FIG. 1, the gantry (1) includes brushes in the form of rotary rollers. A first roller (2) with horizontal appearance, is associated with rollers (3, 4) substantially oriented vertically, the whole being intended for cleaning upper surfaces and lateral sides of the vehicles. These gantries (1), conventionally, move in rectilinear translation relatively to the vehicle to be cleaned (not shown).

According to the invention, a first ramp of nozzles (5) is positioned facing the horizontal roller (2). This ramp (5) includes a succession of nozzles projecting fluid at medium or high pressure (up to 120 bars) towards the brush (2). The ramp (5) mounted on supports (6, 7) attached to the gantry (1) is rotary along one axis, which allows refinement of the orientation of the nozzles relatively to the rollers (2), since they may then be oriented tangentially, radially, or further according to an intermediate position. Their orientation may also vary during the phase for cleaning the roller (2).

Equivalent ramps are provided for cleaning the rollers with a vertical appearance (3, 4). Only the ramp (8) which is applied to the roller (4) is in fact visible in FIG. 1. It is rotary along an axis with a vertical appearance so as to be able to orient the nozzles which it contains relatively to the vertical brushing roller (4). In the same way as before, this orientation may switch from a tangential direction to a radial or normal direction while passing through intermediate positions.

The alternative of FIG. 2 shows a cleaning gantry (10) distinct from the vehicle wash gantry (1), either fixed or mobile, and which includes on its side uprights (11, 12) nozzles oriented facing the rollers of vertical appearance (3, 4). A ramp (13) is moreover positioned in the upper portion of the gantry (10), facing the horizontal upper roller (2). It should be noted that under the assumption illustrated in FIG. 2, the upper ramp (13) will be added to the ramp (5) as already illustrated in the configuration of FIG. 1.

In this alternative of FIG. 2, the illustrated ramps of nozzles have the exclusive function of cleaning the rollers (2, 3, 4). Under the assumption of FIG. 1, the side ramps (8) may also be applied for high pressure washing of the vehicle.

As already mentioned, the washing of the rollers (2, 3, 4) may occur either between two successive washing operations of vehicles, or during intermediate phases, before or after the actual washing (during drying, etc.).

The examples illustrated in FIGS. 1 and 2 are of course not exhaustive of the invention. The latter encompasses other alternatives, for example as regards the shape, configuration or positioning of the gantries, nozzle ramps, etc.

1. A device for cleaning the brushes of a vehicle wash gantry, wherein it includes nozzles projecting a pressurized fluid on the brushes of the wash gantry.

2. The device for cleaning brushes of a vehicle wash gantry according to claim 1, wherein the pressure of the fluid is comprised between 15 and 75 bars.

3. The cleaning device according to claim 1, wherein it includes means for orienting the nozzles relatively to the brushes.

4. The cleaning device according to claim 3, wherein the orientation means are adjustable in order to vary the relative position of the nozzles and of the brushes.

5. The cleaning device according to claim 1, wherein the nozzles are mounted on the vehicle wash gantry.

6. The cleaning device according to claim 1, wherein the nozzles are mounted on a gantry distinct from the vehicle wash gantry.

7. The cleaning device according to claim 1, wherein the nozzles are integrated to at least one ramp.

8. The cleaning device according to claim 7, wherein the ramp(s) are orientable.

9. The device for cleaning brushes of a vehicle wash gantry according to claim 1, wherein it includes a management unit capable of triggering a cycle for washing the brushes on the basis of manual or automated control, the latter being managed by the management unit on the basis of predetermined events stored in memory.

10. The device for cleaning brushes of a vehicle wash gantry according to claim 1, wherein the brushes are rollers performing a rotary movement.

11. The device for cleaning brushes of a vehicle wash gantry according to claim 1, wherein it includes means for mechanically acting on the brushes in order to detach dirt therefrom.

12. The device for cleaning brushes of a vehicle wash gantry according to claim 11, wherein said means for each brush consist in a stringer comb running parallel to the brush and the flexible or rigid teeth of which are capable of interfering with the moving brush.

13. The device for cleaning brushes of a vehicle wash gantry according to claim 1, wherein it includes protective enclosure means for the brushes during cleaning.

14. The device for cleaning brushes of a vehicle wash gantry according to claim 13, wherein the protective enclosure means are mobile between two stable positions, an inactive position and an active position for protecting against projections upon washing the brushes.

15. The device for cleaning brushes of a vehicle wash gantry according to claim 14, wherein the wash gantry including two side brushes with a vertical appearance and an upper brush with a horizontal appearance, the protective enclosure means include for each vertical brush an external side protective body at the contact of which at least one additional protective enclosure face extending at least partly around each vertical brush is retracted in the inactive position and from which said face is deployed in the active position.

16. The device for cleaning brushes of a vehicle wash gantry according to claim 15, wherein the external side protective body consists in metal sheet forming a cylinder portion with an axis substantially equal to the axis of rotation of the rollers forming the brushes, into which a cylinder portion of the same radius of curvature forming the additional face will slide transversely.

17. The device for cleaning brushes of a vehicle wash gantry according to claim 16, wherein the additional face includes, extending substantially radially towards the brush, a comb or at least one strip, the latter or the teeth of the comb penetrating into the volume occupied by the roller and which the latter hits when it is rotating.

18. The device for cleaning brushes of a vehicle wash gantry according to claim 13, wherein the protective enclosure means of the horizontal upper brush consist in a flap.

19. The device for cleaning brushes of a vehicle wash gantry according to claim 14, wherein the displacement of the protective enclosure means is controlled by the processing unit.

20. The cleaning device according to claim 1, wherein the fluid projected by the nozzles is a liquid.

21. The cleaning device according to claim 20, wherein said liquid includes chemical means for cleaning the brushes.

22. The cleaning device according to claim 20, wherein the projected liquid is hot.

23. The cleaning device according to claim 1, wherein the fluid is air.

24. A method for cleaning the brushes of a vehicle wash gantry by means of a device according to claim 1, wherein it consists of spraying a pressurized fluid on said brushes.

25. The cleaning method according to claim 24, wherein the brushes when they are in the form of rotary rollers are set into rotation for their cleaning.

26. The cleaning method according to claim 25, wherein during a cycle for cleaning the brushes, the latter are set into rotation in one direction and in an opposite direction alternately.

27. The cleaning method according to claim 26, wherein the duration of the rotation in each direction is comprised between 3 s and 10 s.

28. The cleaning method according to claim 26, wherein the rollers are brought to a standstill for a predetermined period between each change of direction of rotation.

29. The cleaning method according to claim 25, wherein at certain moments of a cycle for cleaning the brushes, the rollers are driven into rotation during a predetermined period in the absence of spraying of fluid.

30. The cleaning method according to claim 25, wherein the fluid is sprayed onto the brushes during a cycle fraction including 2 to 100 revolutions of said brushes.

31. The cleaning method according to claim 30, wherein said cycle fraction lasts for between 8 and 30 revolutions.

32. The cleaning method according to claim 24, wherein spraying is triggered between two vehicle washing cycles.

33. The cleaning method according to claim 24, wherein a cycle for cleaning the brushes is triggered automatically at the beginning and at the end of a vehicle washing cycle.

34. The cleaning method according to claim 24, wherein the cycle for cleaning the brushes is triggered manually.

35. The cleaning method according to claim 24, wherein a cycle for cleaning the brushes is triggered automatically when at least one predetermined condition which may be quantified by the unit for managing the cleaning is met.

36. The cleaning method according to claim 35, wherein a cycle for cleaning the brushes is triggered automatically when no vehicle washing cycle has been carried out for a predetermined period.

37. The cleaning method according to claim 35, wherein said cleaning cycle lasts for between 40 s and 80 s.

38. The cleaning method according to claim 24, wherein each cycle for cleaning the brushes is coupled to the closing of the protective enclosure means of the brushes, and triggered when said protective enclosure means are in the closed position.

39. The cleaning method according to claim 24, wherein the fluid is sprayed on the brushes according to a variable orientation.
